(19) United States
(12) Patent Application Publication
(10) Pub. No.: US 2026/0124603 A1
(43) Pub. Date: May 7, 2026

(54) COMPOSITE CATALYST FOR HYDROGEN-SELECTIVE CATALYTIC REDUCTION, METHOD OF PREPARING THE SAME, AND AIR PURIFICATION DEVICE INCLUDING COMPOSITE CATALYST

(71) Applicant: Samsung Electronics Co., Ltd., Suwon-si, Gyeonggi-do (KR)

(72) Inventors: Hyeonsu Heo, Suwon-si, Gyeonggi-do (KR); Seunghee Son, Suwon-si, Gyeonggi-do (KR); Dongjin Ham, Suwon-si, Gyeonggi-do (KR); Min Seok Koo, Suwon-si, Gyeonggi-do (KR); Kyeongmin Baek, Suwon-si, Gyeonggi-do (KR); Seoeun Jeong, Suwon-si, Gyeonggi-do (KR); Jaiyoung Chung, Suwon-si, Gyeonggi-do (KR); Jonghyun Ha, Suwon-si, Gyeonggi-do (KR)

(21) Appl. No.: 19/357,177

(22) Filed: Oct. 14, 2025

(30) Foreign Application Priority Data
Nov. 1, 2024 (KR) 10-2024-0153785
Oct. 13, 2025 (KR) 10-2025-0146552

(51) Int. Cl. B01J 23/44; B01D 53/86; B01D 53/94; B01J 29/44; B01J 35/30; B01J 35/61; B01J 35/63; B01J 35/64; B01J 37/02; B01J 37/04; B01J 37/08; B01J 37/16; B01J 37/30

(52) U.S. Cl. CPC B01J 23/44; B01D 53/8628; B01D 53/9418; B01J 29/44; B01J 35/394; B01J 35/615; B01J 35/633; B01J 35/647; B01J 35/651; B01J 37/0207; B01J 37/0236; B01J 37/04; B01J 37/088; B01J 37/16; B01J 37/30; B01D 2251/202; B01D 2255/1021; B01D 2255/1023; B01D 2257/404; B01D 2258/01; B01D 2258/06

(57) ABSTRACT

Provided are a composite catalyst for H₂-SCR, a method of preparing the same, and an air purification device including the composite catalyst, the composite catalyst being configured to remove a first compound from an unpurified air stream containing the first compound, and including a support and catalyst particles supported on the support, wherein the catalyst particles include a metal, a metal oxide, or a combination thereof, the metal includes platinum and a platinum group element, and a content of the platinum is 3 parts by weight or more per 1 part by weight of the platinum group element.

### CROSS-REFERENCE TO RELATED APPLICATION

This application is based on and claims priority to Korean Patent Application Nos. 10-2024-0153785, filed on Nov. 1, 2024, and 10-2025-0146552, filed on Oct. 13, 2025, in the Korean Intellectual Property Office, and all the benefits accruing therefrom under 35 U.S.C. § 119, the disclosures of which are incorporated by reference herein in its entirety.

### BACKGROUND

### 1. Field

The disclosure relates to a composite catalyst for hydrogen-selective catalyst reduction (H₂-SCR), a method of preparing the composite catalyst, and an air purification device including the composite catalyst.

### 2. Description of the Related Art

Recently, due to the high integration of semiconductors in a variety of products, the types and amounts of reaction gases used during a manufacturing process of the semiconductors have increased. Accordingly, the types and amounts of harmful substances in harmful gases are also increasing, and thus various harmful gas treatment methods are being used.

A heat recovery oxidation method using a regenerative thermal oxidizer (RTO) is a known method of treating harmful gases. This method has a very high heat recovery efficiency of 95% or more by recovering and reusing waste heat and has also a very high processing efficiency of 98% or more, and thus is currently widely used in the latter stages of a semiconductor process.

However, during the RTO process, harmful gases containing highly toxic harmful substances such as nitrogen oxides (NOx), silane, tetramethyl silane, trimethylamine, halogens, hydrocarbons, and sulfur compounds may be generated during the latter stages. Malodorous gases that are emitted without being treated in the RTO process may cause air pollution and have a negative impact on the human body. Therefore, there is a need for an efficient pollutant removal method that can be applied where malodorous and/or harmful gases are generated and not removed in the latter stages of the RTO process.

### SUMMARY

Provided is a composite catalyst for H₂-SCR, which provides improved harmful gas removal capability.

Provided is a method of preparing the composite catalyst for H₂-SCR.

Provided is an air purification device including the composite catalyst for H₂-SCR.

Additional aspects will be set forth in part in the description which follows and, in part, will be apparent from the description, or may be learned by practice of the presented embodiments of the disclosure.

According to an aspect of the disclosure, a composite catalyst for hydrogen-selective catalyst reduction (H₂-SCR) is configured to remove a first compound from an unpurified air stream containing the first compound, and includes
a support and
catalyst particles supported on the support,
wherein the catalyst particles include a metal, a metal oxide, or a combination thereof,
the metal includes platinum and a platinum group element different from platinum, and
the content of the platinum is 3 parts by weight or more based on 1 part by weight of the platinum group element.

The platinum group element may be palladium (Pd), ruthenium (Ru), rhodium (Rh), osmium (Os), iridium (Ir), or a combination thereof, and a mixing weight ratio of the platinum and the platinum group element may be 3:1 to 1,000:1, or 4:1 to 300:1.

The content of the catalyst particles may be about 0.1 weight percent (wt %) to about 5 wt % based on the total weight of the composite catalyst.

The metal oxide may be PtOₓ wherein 0<x≤2, PdO_{y} wherein 0<x≤1, RuOₓ wherein 0<x≤2, RuₐOₓ wherein 0<a≤2, 0<x≤3, OsOₓ wherein 0<x≤2, IrOₓ wherein 0<x≤2, or a combination thereof, and, for example, may be PdO, PtO₂, RuO₂, Rh₂O₃, OSO₂, Ir₂O₃, or a combination thereof.

The support may include SiO₂, Al₂O₃, zeolite, TiO₂, or a combination thereof.

The support may be an aluminosilicate in an amorphous or crystalline state. The support may be an aluminosilicate, and may have a silicon to aluminum (Si/Al) rate of 50 or less and a mesopore volume rate of about 20% to about 80%.

The composite catalyst may include platinum (Pt) and palladium (Pd). The composite catalyst may further include oxides of platinum (Pt) and palladium (Pd).

The composite catalyst may include a compound represented by Formula 1 below:

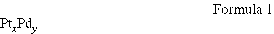

wherein 0.8<x≤0.99 and 0.01≤y≤0.2.

The support may further include mesopores, and an average size of the mesopores is about 2 nanometers (nm) to about 50 nm.

In the composite catalyst, the average particle diameter of the catalyst particles may be about 5 nm to about 300 nm, the average particle diameter of the platinum may be about 5 nm to about 300 nm. When the catalyst particles have an alloy forms, the average particle diameter of the catalyst particles may have the above-described range. When the catalyst particles have separate particle forms, and the average particle diameter of the platinum group element may be about 1 nm to about 10 nm. Here, the platinum group element may be, for example, palladium.

The composite catalyst according to an embodiment may be capable of use under conditions an O₂ content of about 5 volume percent (vol %) to about 20 vol % and a temperature of about 70° C. to 125° C. The composite catalyst may have a NO conversion rate of 40% or more and a N₂ selectivity of more than 60% under conditions of an O₂ content of about 5 vol % to about 20 vol % and a temperature of about 70° C. to 125° C.

The first compound may include a volatile organic compound (VOC).

According to another aspect of the disclosure, a method of preparing the composite catalyst for H₂-SCR includes: providing a support;
supporting a platinum-containing salt and a platinum group element-containing salt that does not include platinum as catalyst particle precursors on the prepared support to obtain a support on which the catalyst particle precursors are supported; and
mixing the support on which the catalyst particle precursors are supported with a reducing agent to obtain a mixture on the support; and optionally, drying the mixture on the support; and
heat-treating the dried mixture on the support to prepare the composite catalyst.

The reducing agent may be hydrazine, sodium borohydride, or a combination thereof.

In the process of supporting a platinum-containing salt and a platinum group element-containing salt as catalyst particle precursors on the prepared support, a dry impregnation method may be used.

The support may be a support having mesopores, and this support may be prepared by the following processes of: providing a bare support; contacting the bare support with an alkaline solution to prepare a alkali-treated support; performing a first heat-treatment on the alkali-treated support to prepare a heat-treated porous support; contacting the heat-treated porous support with an ammonium salt-containing solution to prepare an ion exchange-treated support; and drying and then heat-treating the ion exchange-treated support.

The heat treatment may be performed at about 300° C. to about 900° C. in an inert gas atmosphere.

According to another aspect of the disclosure, an air purification device includes a housing, and
the composite catalyst for H₂-SCR,
wherein the composite catalyst is disposed within the housing.

The air purification device may have an operation temperature of about 70° C. to about 125° C., an oxygen (O₂) content of about 5 vol % to about 20 vol % or about 10 vol % to about 20 vol %, and a nitrogen (N₂) content of about 80 vol % to about 95 vol %. In the air purification device, an injection amount of hydrogen (H₂) gas may be about 100 parts per million (ppm) to about 40,000 ppm based on a total weight of exhaust gas and hydrogen gas.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A to 1C show scanning transmission electron microscopy (STEM)-energy dispersive X-ray (EDX) images of a composite catalyst prepared in Example 1;

FIGS. 2A to 2C show STEM-EDX images of a composite catalyst prepared in Comparative Example 3;

FIG. 3 is a graph showing nitrogen oxide conversion rates (NO conversion rates) (percent, %) versus temperature (Celsius, ° C.) of the results of nitrogen oxide removal experiments for composite catalysts of Example 1-2 and Comparative Example 1-4;

FIG. 4 is a graph showing nitrogen gas selectivity (percent, %) versus temperature (Celsius, ° C.) of the results of nitrogen oxide removal experiments for composite catalysts of Example 1-2 and Comparative Example 1-4;

FIG. 5 is a schematic view of a catalytic filter according to an embodiment;

FIG. 6 is a front view of an inflow side of the catalytic filter of FIG. 5, through which unpurified air is introduced;

FIG. 7 is a front view of an outflow side of the catalytic filter of FIG. 5, through which purified air is discharged;

FIG. 8 is a cross-sectional view of the catalytic filter of FIG. 5, taken along line 4-4′ shown in FIG. 6; and

FIG. 9 is an enlarged cross-sectional view of a first portion A1 in FIG. 8.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept, which will be more fully described hereinafter, may have various variations and various embodiments, and specific embodiments will be illustrated in the accompanied drawings and described in greater detail. However, the present inventive concept should not be construed as being limited to specific embodiments set forth herein. Rather, these embodiments are to be understood as encompassing all variations, equivalents, or alternatives included in the scope of the present inventive concept.

The terminology used hereinbelow is used for the purpose of describing particular embodiments only, and is not intended to limit the present inventive concept. As used herein, the singular forms are intended to include the plural forms as well, unless the context clearly indicates otherwise. As used herein, the terms “comprises” and/or “comprising,” or “includes” and/or “including” specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof. As used herein, “!” may be interpreted as “and”, or as “or” depending on the context.

In the drawings, the thicknesses of layers and regions may be exaggerated for clarity of description. Like reference numerals denote like elements throughout the specification. Throughout the specification, when a component, such as a layer, a film, a region, or a plate, is described as being “above” or “on” another component, the component may be directly above the another component, or there may be yet another component therebetween. It will be understood that although the terms “first,” “second,” etc. may be used herein to describe various elements, these elements should not be limited by these terms. These terms are only used to distinguish one element from another element. In the present specification and the drawings, elements that serve substantially the same function are labeled with the same reference numeral and may not be discussed redundantly.

Unless otherwise defined, the term “size” of a particle may refer to “particle diameter” of the particle.

The term “particle diameter” of particles, as used herein, refers to an average diameter if the particles are spherical, and refers to an average major axis length if the particles are non-spherical. The particle diameter of particles may be measured using a particle size analyzer (PSA). The term “particle diameter” of particles, as used herein, refers to, for example, an average particle diameter. Average particle diameter may be, for example, a median particle diameter (D50). Median particle diameter (D50) may refer to a particle size corresponding to a cumulative volume of 50 vol % as counted from the smallest particle size in a particle size distribution measured by a laser diffraction method. Alternatively, “average particle diameter” may be measured by software or a manual from a scanning electron microscope (SEM) image or a transmission electron microscope (TEM) image.

The term “metal” as used herein refers to both metals and metalloids such as silicon and germanium, in an elemental or ionic state.

Nitrogen oxides (NOx) are substances mainly generated from vehicle internal combustion engine, power plants that use high temperatures, and steel mills. They are substances that cause acid rain and ozone layer destruction, and are also substances that generate fine dust through secondary reactions, so their removal before being released into the atmosphere is essential. To date, selective catalytic reduction (SCR) using a post-treatment catalyst for reducing nitrogen oxides has been studied and commercialized. When removing nitrogen oxides, a selective non-catalytic reduction (SNCR) or selective catalytic reduction (SCR) method using a reducing agent such as ammonia or urea is used. In the case of SNCR, a high temperature of about 950° C. to about 1150° C. is required for reactions, and in the case of NH₃-SCR using a catalyst, a temperature of about 350° C. to about 400° C. is usually required. Additionally, unreacted NH₃ is legally controlled as an air pollutant and therefore requires strict management.

However, in the case of H₂-SCR using H₂ as a reducing agent, the reaction temperature is low, i.e., 150° C. or less, so nitrogen oxides (NOₓ) can be removed using lower energy, but there is an urgent need to develop a catalyst that can remove nitrogen oxides (NOₓ) in the atmospheric environment outside of internal combustion engines.

Hereinafter, according to embodiments, a composite catalyst for hydrogen selective catalytic reduction (H₂-SCR), an air purification device including the same, and a method of preparing a composite catalyst will be described in more detail.

In the present disclosure, the composite catalyst for H₂-selective catalytic reduction (H₂-SCR) refers to an SCR composite catalyst that reduces harmful gases by using hydrogen.

### Composite Catalyst for H₂-SCR

A composite catalyst according to an embodiment is configured to remove a first compound from an unpurified air stream containing the first compound. The composite catalyst configured to remove a first compound from an unpurified air stream containing the first compound includes: a support; and catalyst particles supported on the support, wherein the catalyst particles include a metal, a metal oxide, or a combination thereof, the metal includes platinum and a platinum group element different from platinum, and a content of the platinum is 3 parts by weight or more per 1 part by weight of the platinum group element. It is to be understood that “catalyst particles” as used herein does not mean that the functionality of the composite catalyst is limited solely to these particles.

In an embodiment, the platinum group element excludes platinum, and may include palladium (Pd), ruthenium (Ru), rhodium (Rh), osmium (Os), iridium (Ir), or a combination thereof, and specifically, palladium.

The composite catalyst may be used to remove NOx from exhaust gas by using hydrogen as a reducing agent. When the content of platinum is 3 parts by weight or more per 1 part by weight of the content of the platinum group element, the composite catalyst exhibits higher activity at a lower reaction temperature as compared to a catalyst made of platinum alone. When the content of platinum is less than 3 parts by weight per 1 part by weight of the content of the platinum group element, the ability of the composite catalyst to remove harmful gases such as nitrogen oxides (NOx) deteriorates.

The mixing weight ratio of the platinum and the platinum group element is about 3:1 to about 999:1 (9.99:0.01), about 3:1 to about 900:1, about 3:1 to about 700:1, about 3:1 to about 600:1, about 3:1 to about 300:1, about 4:1 to about 250:1, about 4:1 to about 200:1, about 4:1 to about 150:1, about 4:1 to about 120:1, about 4:1 to about 100:1, about 4:1 to about 80:1, about 4:1 to about 50:1, about 4:1 to about 30:1, about 4:1 to about 15:1, about 4:1 to about 10:1, or about 4:1 to about 9:1. When the weight ratio of the platinum and the platinum group element is within the above range, the ability of the composite catalyst to remove nitrogen oxide is improved.

The metal oxide may be represented by Formula MₐO_{b} (0<a≤4, 0<b≤5, wherein M is platinum (Pt), ruthenium (Ru), rhodium (Rh), osmium (Os), iridium (Ir), palladium (Pd), or a combination thereof). The metal oxide may be, for example, PtOₓ (0<x≤2), PdO_{y} (0<x≤1), RuOₓ (0<x≤2), OsOₓ (0<x≤2), IrOₓ (0<x≤2), RuₐOₓ wherein 0<a≤2, 0<x≤3, or a combination thereof.

The metal oxide may include, for example, PtO₂, RuO₂, Rh₂O₃, OsO₂, Ir₂O₃, PdO, or a combination thereof.

The composite catalyst may include platinum (Pt) and palladium (Pd). The composite catalyst may further include an oxide including platinum (Pt), an oxide including palladium, or a combination thereof.

The catalyst according to an embodiment is a compound represented by Formula 1 below:

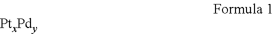

wherein, in Formula 1, 0.8≤x≤0.99, and 0.01≤y≤0.2. For example, 0.8≤x≤0.9, and 0.1≤y≤0.2. Here, x+y=1.

When a H₂-SCR reaction is performed in the presence of oxygen by using the composite catalyst according to an embodiment, nitrogen oxides (NOₓ) from exhaust gas are converted into N₂ and H₂O, thereby removing nitrogen oxides.

A composite catalyst according to an embodiment may be used to remediate harmful gases such as nitrogen oxides emitted from internal combustion engines, thereby improving a nitrogen oxide removal ability.

The catalyst particles are supported on a support, and removal ability for various volatile organic compounds included in unpurified air is improved by including catalyst particles containing platinum and a platinum group element.

The support may be SiO₂, Al₂O₃, zeolite, TiO₂, or a combination thereof. The support may be amorphous or crystalline aluminosilicate.

When the support is aluminosilicate, it has a Si:Al ratio of 50:1 or less, 40:1 or less, about 10:1 to about 40:1, about 10:1 to about 30:1, or about 22:1 to about 25:1, and has a mesoporosity (volume of mesopores) of about 20 vol % to about 80 vol %, about 30 vol % to about 80 vol %, about 40 vol % to about 80 vol %, about 50 vol % to about 80 vol %, or about 60 vol % to about 80 vol %. When the support has the above-described Si:Al ratio and mesoporosity, material transfer becomes easier. Therefore, the removal of volatile organic compounds having increased size becomes easier. The composite catalyst can further promote the decomposition reaction of volatile organic compounds by including the catalyst particles supported on the support. As a result, the composite catalyst may remove volatile organic compounds more effectively. For example, the rate of removal reactions of volatile organic compounds may increase. For example, the temperature at which nitrogen oxides, which are volatile organic compounds, are converted into nitrogen may be lowered. Therefore, the ability of the composite catalyst to remove various volatile organic compounds included in unpurified air may be improved.

The composite catalyst according to an embodiment includes a support, and the support may include aluminosilicate. The support may have a crystalline phase.

The support may be particulate, where the size of the support particles may be, for example, about 0.5 micrometers (μm) to about 500 μm, about 0.5 μm to about 100 μm, about 0.5 μm to about 50 μm, about 0.5 μm to about 10 μm, or about 1 μm to about 5 μm.

Since the support has a size in this range, the performance of composite catalysts in removing volatile organic compounds may be further improved. The size of the support particles may be, for example, a diameter of the support particles as measured from a scanning electron microscope image or transmission electron microscope image. The size of the support particles may be, for example, an average particle diameter. The average particle diameter may be measured by using, for example, a measurement device using a laser diffraction technique or a dynamic light scattering technique. The average particle diameter is measured using, for example, a laser scattering particle size distribution system (for example, LA-920, Horiba Inc.), and is a value of median particle size (D50) when 50% of the small particles are accumulated in volume conversion.

The support may include, for example, irregular particles, spherical particles having an aspect ratio of less than 2, non-spherical particles having an aspect ratio of 2 or more, or a combination thereof. The spherical particles may have an aspect ratio of, for example, 1.9 or less, 1.5 or less, or 1.2 or less. The spherical particles may have a sphericity of, for example, 0.85 or more, 0.9 or more, or 0.95 or more. The sphericity of the spherical particle may be calculated from, for example, Ψ=[π^{1/3}(6Vₚ)^{2/3}]/Aₚ, wherein Ψ represents sphericity, Vₚ represents the volume of the particle, and Aₚ represents the surface area of the particle. The roundness of the spherical particle in a 2D projected image of the particle, may be, for example, 0.85 or more, 0.9 or more, or 0.95 or more. The roundness of the spherical particle may be calculated by C=[4πA]/P², wherein C represents roundness, A represents a surface area of the particle, and P represents a perimeter of the particle. Non-spherical particles may have an aspect ratio of, for example, 2 or more, 2.5 or more, or 3 or more. The aspect ratio of the non-spherical particle may be, for example, about 2 to about 100, about 2.5 to about 100, or about 3 to about 100. The sphericity of the non-spherical particle may be less than 0.8. The roundness of the non-spherical particles in a two-dimensional image may be less than 0.8. The non-spherical particles may include, for example, tube-shaped particles, plate-shaped particles, needle-shaped particles, rod-shaped particles, fibrous particles, or a combination thereof.

In an embodiment, the composite catalyst may include a support, the support may include amorphous aluminosilicate, and the amorphous aluminosilicate may be, for example, porous amorphous aluminosilicate. For example, the support may be porous. The porous amorphous aluminosilicate may include a plurality of pores, and the plurality of pores may be irregularly or non-periodically arranged within the amorphous aluminosilicate. For example, porous amorphous aluminosilicate particles may include a plurality of pores arranged within the particles, and the plurality of pores may be irregularly or non-periodically arranged within the amorphous aluminosilicate particles.

The porous aluminosilicate may include, for example, mesopores. The mesopores may refer to pores having a size of about 2 nm to about 50 nm. The volume of the mesopores may be about 20 vol % to about 80 vol %, 30 vol % to about 80 vol %, 40 vol % to about 80 vol %, 50 vol % to about 80 vol %, or about 60 vol % to about 80 vol %, with respect to the total volume of pores in the porous amorphous aluminosilicate. With the volume of the mesopores in the above ranges, the performance of the composite catalyst in removing volatile organic compounds may be further improved. The average size of the mesopores may be, for example, about 3 nm to about 50 nm, about 3 nm to about 40 nm, about 3 nm to about 30 nm, about 4 nm to about 20 nm, about 5 nm to about 15 nm, or about 10 nm to about 15 nm. With the mesopores having an average size in the above ranges, the composite catalyst may effectively remove volatile organic compounds having increased sizes. The size of mesopores may be measure by methods such as a nitrogen adsorption method or a mercury intrusion porosimetry technique.

The porous amorphous aluminosilicate may further include micropores in addition to mesopores. The porous amorphous aluminosilicate may include micropores and mesopores. Micropores refers to pores each having a size of less than 2 nm. In a pore size distribution diagram of the porous amorphous aluminosilicate obtained by a nitrogen adsorption method, the pore volume of the mesopores may be greater than the pore volume of the micropores. In the total pore volume of pores included in the porous amorphous aluminosilicate, a first pore volume occupied by mesopores may be greater than a second pore volume occupied by micropores. In the total pore volume of pores included in the porous amorphous aluminosilicate, a first pore volume occupied by mesopores may be more than 100%, 110% or more, 120% or more, 150% or more, or 200% or more, with respect to a second pore volume occupied by micropores. In the total pore volume of pores included in the porous amorphous aluminosilicate, a first pore volume occupied by mesopores may be more than 100% and not more than about 1,000%, about 110% to about 500%, about 120% to about 400%, about 150% to about 300%, or about 200% to about 300%, with respect to a second pore volume occupied by micropores. With the porous amorphous aluminosilicate having a first pore volume in the above ranges, the composite catalyst may have a further improved ability to remove volatile organic compounds.

In a pore size distribution diagram of the porous amorphous aluminosilicate obtained by a nitrogen adsorption method, the maximum value of differential pore volume of mesopores may be 0.1 cubic centimeters per gram (cm³/g) or more, 0.11 cm³/g or more, or 0.12 cm³/g or more. In a pore size distribution diagram of the porous amorphous aluminosilicate obtained by a nitrogen adsorption method, the maximum value of differential pore volume of mesopores having a size of about 5 nm to about 50 nm may be 0.1 cm³/g or more, 0.11 cm³/g or more, or 0.12 cm³/g or more. Since the maximum value of differential pore volume of mesopores in the pore size distribution diagram of the porous amorphous aluminosilicate obtained by a nitrogen adsorption method is within the above ranges, the composite catalyst may have a further improved ability to remove volatile organic compounds.

The catalyst particles may be non-homogeneously supported on the support. The support may include an inner portion and an outer portion. The inner portion of the support may be defined, for example, by a second distance, which is a distance between a point corresponding to 80% of a first distance and the geometric center of the support, wherein the first distance is a distance between the geometric center of the support and a surface of the support. The outer portion of the support may be disposed on the inner portion of the support. The outer portion of the support may be defined by a third distance, which is a distance between a point corresponding to 80% of the first distance, e.g., the surface of the inner portion, and the surface of the support. The catalyst particles may be optionally supported on a portion of the support. All or part of the catalyst particles may be optionally disposed in the outer portion of the support. With the catalyst particles optionally disposed in the outer portion of the support, the composite catalyst may have a further improved rate of removal of volatile organic compounds. The amount of catalyst particles disposed in the outer portion of the support may be higher than the amount of catalyst particles disposed in the inner portion of the support. The ratio of the amount of catalyst particles disposed in the outer portion of the support to the amount of catalyst particles disposed in the inner portion of the support may be more than 100%, 110% or more, 120% or more, 150% or more, or 200% or more. The ratio of the amount of catalyst particles disposed in the outer portion of the support to the amount of catalyst particles disposed in the inner portion of the support may be more than 100% and not more than about 500%, about 110% to about 500%, about 120% to about 500%, about 150% to about 400%, or about 200% to about 300%. Since the amount of catalyst particles disposed in the outer portion of the support is more than the amount of catalyst particles disposed in the inner portion of the support, the composite catalyst may have a further improved rate of removal of volatile organic compounds.

The size of catalyst particles may be, for example, about 1 nm to about 300 nm, about 5 nm to about 200 nm, or about 10 nm to about 150 nm. In a composite catalyst according to an embodiment, the average particle size of platinum is about 1 nm to about 300 nm, about 5 nm to about 200 nm, or about 10 nm to about 150 nm, and the average particle size of the platinum group element such as palladium is about 1 nm to about 10 nm, about 2 nm to about 8 nm, or about 3 nm to about 7 nm. With the catalyst particles, the platinum, and the platinum group element having sizes in the above ranges, the composite catalyst may have a further increased effective contact area with a volatile organic compound. Consequently, the composite catalyst may have a further improved rate of removal of volatile organic compounds. The size of the catalyst particles may be, for example, a diameter of catalyst particles measured from a scanning electron microscope image or a transmission electron microscope image. The size of the catalyst particles may be, for example, an average particle diameter. The average particle diameter may be measured, for example, by a measurement device using a laser diffraction technique or a dynamic light scattering technique. The average particle size is measured, for example, using a laser scattering particle size distribution meter (e.g., LA-920, Horiba Inc.), and is a value of median particle size (D50) when 50% of the smallest particles are accumulated in volume conversion.

The amount of the catalyst particles may be about 0.1 wt % to about 5 wt %, about 0.1 wt % to about 4 wt %, about 0.1 wt % to about 3 wt %, about 0.1 wt % to about 2 wt %, or about 0.1 wt % to about 1 wt %, with respect to the total weight of the composite catalyst. With the catalyst particles in an amount in the above ranges, the composite catalyst may exhibit further improved performance in removing volatile organic compounds. If the amount of the catalyst particles is excessively low, the expected effect may be insignificant. If the amount of the catalyst particles is excessively high, the increase in catalytic effect due to an increased amount may be insignificant.

An unpurified air stream may include a first compound, and the first compound may include, for example, a volatile organic compound (VOC). The VOC is not particularly limited and may include any or all volatile organic compounds that are regarded as harmful to the human body or to the environment in industry locally or overseas. The VOC may include, for example, a polar compound, a nonpolar compound, or a combination thereof.

The VOC may be, for example, a nonpolar compound. The nonpolar compound may include, for example, an aliphatic hydrocarbon, an aromatic hydrocarbon, or a combination thereof. The aliphatic hydrocarbon and the aromatic hydrocarbon may be unsubstituted, or may be substituted with a substituent. The substituent may be, for example, an alkyl group, an alkenyl group, an alkynyl group, a cycloalkyl group, an aryl group, a heteroaryl group, an aralkyl group, a cycloalkenyl group, a heterocyclyl group, a halogen, or the like. The aliphatic hydrocarbon may include, for example, methane, ethane, propane, butane, pentane, hexane, or a combination thereof. The aromatic hydrocarbon may include, for example, benzene, toluene, xylene, or a combination thereof.

The VOC may be, for example, a polar compound. The polar compound may include, for example, ammonia (NH₃), an amine compound, an aldehyde compound, a ketone compound, an alcohol compound, a sulfur compound, a thiol compound, a halogenated hydrocarbon, a nitrogen oxide (NOₓ), a sulfur oxide (SOₓ), ozone, or a combination thereof. The nitrogen oxide (NOₓ) includes nitric oxide (NO), nitrogen dioxide (NO₂), N₂O₃ (nitrogen trioxide), N₂O (nitrous oxide), N₂O₄, N₂O₅, or a combination thereof.

The amine compound may include, for example, methylamine, dimethylamine, trimethylamine, ethylamine, aniline, or a combination thereof. The aldehyde compound may include, for example, formaldehyde, acetaldehyde, propionaldehyde, butyraldehyde, or a combination thereof. The ketone compound may include, for example, dimethyl ketone, methyl ethyl ketone, diethyl ketone, methyl propyl ketone, dipropyl ketone, or a combination thereof. The alcohol compound may include, for example, methanol, ethanol, propanol, isopropanol, butanol, pentanol, hexanol, heptanol, or a combination thereof. The sulfur compound may include, for example, hydrogen sulfide, sulfur dioxide, elemental sulfur, sulfur oxide (SOₓ), or a combination thereof. The thiol compound may include, for example, methanethiol, ethanethiol, 1-propanethiol, 2-propanethiol, butanethiol, tert-butyl mercaptan, thiophenol, or a combination thereof.

The composite catalyst may further include a solid substrate. The composite catalyst may include, for example, a solid substrate, and a support disposed on the solid substrate. The solid substrate is not limited to any particular material, and may be formed of, for example, a polymer, a ceramic, a metal, or the like. The solid substrate is not limited to any particular form, and may be in the form of a mesh, a foam, a woven fabric, a non-woven fabric, a honeycomb structure, or the like. The support and the solid substrate may be disposed, for example, across an air stream and between upstream and downstream of the air stream. For example, the air stream may be arranged such that the air stream sequentially passes through one side of the support and the solid substrate and then the other side opposing the one side. The support may be positioned upstream of the air stream, relative to the solid substrate. That is, the support may be positioned such that the support comes into contact with the air stream before the solid substrate does. Alternatively, the support and the solid substrate may be disposed along the air stream, for example, from upstream of the air stream toward downstream of the air stream. For example, the air stream may be positioned such that the air stream moves along one side of the support and the solid substrate, and/or the other side opposing the one side. The support may have catalyst particles supported thereon. A composite catalyst including a solid substrate and a support disposed on the solid substrate may form, for example, a catalytic filter.

The composite catalyst according to an embodiment may be used in the treatment of odorous and/or harmful gases generated in a semiconductor manufacturing process, and is a catalyst capable of removing nitrogen oxides (NOₓ) in the general atmosphere.

In particular, this composite catalyst may be used to remove odorous harmful gases that are emitted without being treated in a regenerative thermal oxidizer (RTO).

The composite catalyst according to an embodiment may be used under conditions of an O₂ content of about 5 vol % to about 20 vol % (a residue of nitrogen) and a temperature of about 70° C. to 150° C., about 85° C. to 125° C., or about 85° C. to 100° C. A catalyst consisting of only palladium is not active under the above oxygen concentration. However, the composite catalyst according to an embodiment includes platinum in an amount of 3 parts by weight or more per 1 part by weight of a platinum group element, thereby exhibiting a synergistic effect between the platinum and the platinum group element, so that the composite catalyst may exhibit high activity under an atmospheric oxygen concentration and at a low reaction temperature (for example, about 75° C. to about 150° C. or about 85° C. to about 125° C.). Here, activity includes both an NO conversion rate and nitrogen selectivity.

The NO conversion rate of the composite catalyst may be obtained under the conditions of an O₂ content of about 5 vol % to about 20 vol % and a temperature of about 70° C. to about 125° C., about 85° C. to about 125° C., or about 85° C. to about 100° C. The composite catalyst may have an NO conversion rate of 40% or more, 45% or more, 50% or more, or about 50% to about 85% and a N₂ selectivity of more than 60%, about 61% to about 80%, or about 62% to about 78% under conditions of an O₂ content of about 10 vol % to about 20 vol %, a N₂ content of about 80 vol % to about 90 vol %, and a temperature of about 70° C. to about 125° C., about 85° C. to about 125° C., or about 85° C. to about 100° C.

The condition of about 70° C. to about 125° C. is, for example, a condition of about 75° C. to about 125° C., a condition of about 80° C. to about 125° C., a condition of more than 85° C. and less than 125° C., or a condition of about 85° C. to about 100° C.

When the O₂ content is in the above ranges, for example under atmospheric conditions of about 10 vol % to about 20 vol % (N₂ content of about 80 vol % to about 90 vol %), palladium has high activity for oxygen and thus hardly exhibits activity as a catalyst. However, a composite catalyst according to an embodiment exhibits high catalytic activity at an unexpectedly low temperature when it has a composition in which the content of platinum is 3 parts by weight or more per 1 part by weight of a platinum group element. In contrast, when the content of platinum is less than 3 parts by weight per 1 part by weight of the platinum group element, the catalytic activity deteriorates under the above atmospheric conditions.

### Air Purification Device Using the Composite Catalyst for H₂-SCR

An air purification device according to another embodiment may include a housing and the above composite catalyst, wherein the composite catalyst is disposed within the housing. The air purification device may purify unpurified air more easily by including the composite catalyst disposed within the housing. The housing is not limited to any particular form, but may utilize any form capable of accommodating a composite catalyst therein. The air purification device may include, for example, a housing and a catalytic filter disposed within the housing. The catalytic filter may be a composite catalyst including a solid substrate and a support that is disposed on the solid substrate and has catalyst particles supported thereon. The housing is not limited to any particular form, and may include an air inlet and an air outlet, wherein a composite catalyst is disposed between the air inlet and the air outlet.

A composite catalyst, for example, in the form of a catalytic filter, may be mounted on various indoor and outdoor air purification devices, such as air purifiers, air purification facilities, and air conditioning equipment, to remove volatile organic compounds or fine particles from unpurified air. A composite catalyst may also be applied to air purification devices and air purification systems to remove odorous substances, germs, pathogens, bacteria, and the like, as well as volatile organic compounds.

For example, a catalytic filter, which has a composite catalyst disposed on a solid substrate, may be provided.

The air purification device has an operation temperature of about 70° C. to about 125° C., about 75° C. to about 125° C., about 80° C. to about 125° C., about 85° C. to about 125° C., or about 85° C. to about 100° C., an oxygen (O₂) content of about 5 vol % to about 20 vol %, or about 10 vol % to about 20 vol %, and a nitrogen (N₂) content of about 80 vol % to about 95 vol %.

In the air purification device, the injection amount of hydrogen (H₂) gas is about 100 ppm to about 40,000 ppm, about 100 ppm to about 30,000 ppm, about 100 ppm to about 25,000 ppm, about 100 ppm to about 20,000 ppm, about 100 ppm to about 15,000 ppm, about 100 ppm to about 10,000 ppm, about 100 ppm to about 8,000 ppm, or about 300 ppm to about 5,000 ppm, based on the total weight of exhaust gas and hydrogen gas.

In this specification, the ppm content of hydrogen gas refers to a weight of hydrogen gas per million of the total weight of exhaust gas and hydrogen gas.

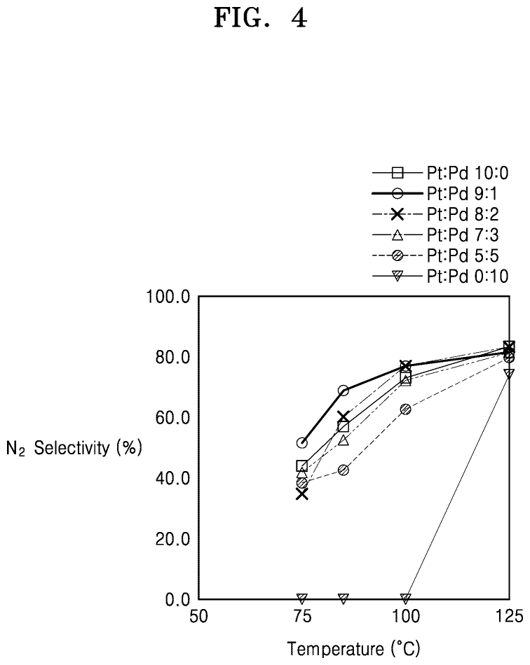

According to an example embodiment, a catalytic filter and an air purification system including the catalytic filter will be described in more detail with reference to FIGS. 5 to 9.

Referring to FIG. 5, a catalytic filter 100 includes an inflow side through which unpurified air 130 is introduced, and an outflow side through which purified air 140 is discharged. The unpurified air 130 may include one or more first compounds.

The unpurified air 130 may include, for example, a particulate first compound, a gaseous first compound, or a combination thereof. The catalytic filter 100 may have a thickness T1 defined by a direction that extends from the inflow side to the outflow side (direction of Y-axis in FIG. 5).

The catalytic filter 100 may include a plurality of first recessed portions 110, each of which has an entrance portion located adjacent to the inflow side through which the unpurified air 130 is introduced, and has a bottom portion located adjacent to the outflow side through which the purified air 140 is discharged. The unpurified air 130 may be introduced into the catalytic filter 100 through the plurality of first recessed portions 110. The plurality of first recessed portions 110 may be arranged regularly and/or periodically. The plurality of first recessed portions 110 may be, for example, arranged in parallel to one another along the direction of the X-axis and/or the direction of the Z-axis in FIG. 5.

The catalytic filter 100 may include a plurality of first surfaces 120S exposed on the inflow side through which the unpurified air 130 is introduced. The plurality of first surfaces 120S may be arranged regularly and/or periodically. The plurality of first surfaces 120S may be, for example, disposed among the plurality of first recessed portions 110.

The plurality of first surfaces 120S may be, for example, spaced apart from one another while being disposed among the plurality of first recessed portions 110 that are spaced apart from one another in one direction along the inflow side, for example, in the direction of the X-axis and/or the direction of the Z-axis in FIG. 5. In one direction along the inflow side, for example, along the direction of the X-axis and/or the direction of the Z-axis in FIG. 5, the plurality of first surfaces 120S and the plurality of first recessed portions 110 may be arranged in an alternating fashion. One first recessed portion 110 may be surrounded by four first surfaces 120S, and one first surface 120S may be surrounded by four first recessed portions 110.

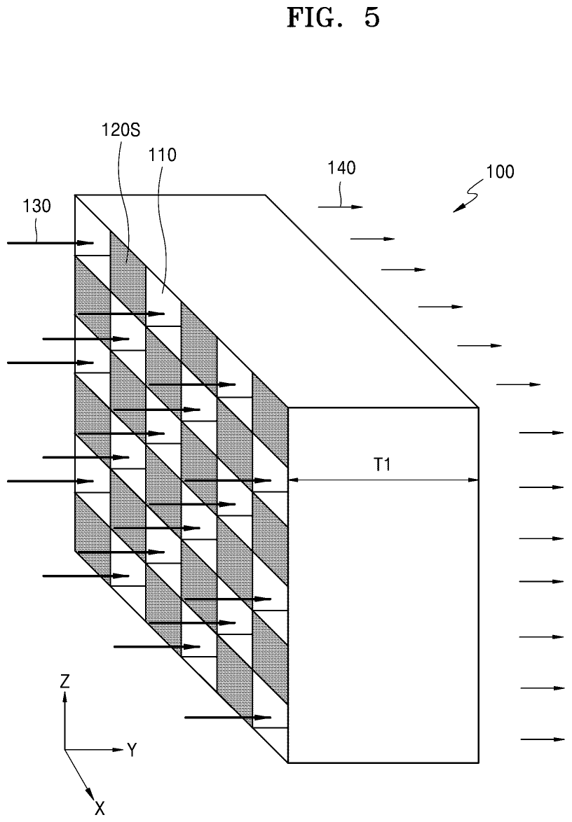

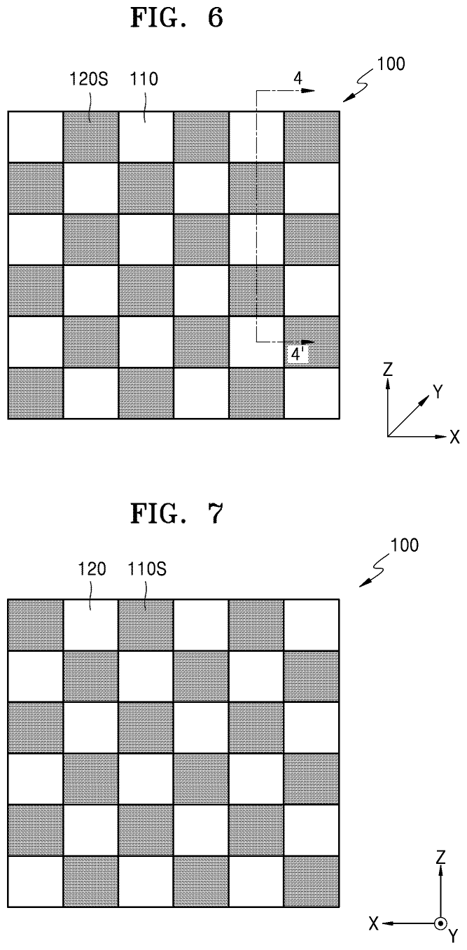

FIG. 6 is a front view of a front side, i.e., an inflow side, of the catalytic filter 100 in FIG. 5. FIG. 7 is a front view of a rear side, i.e., an outflow side, of the catalytic filter 100 in FIG. 5.

Referring to FIG. 6, the inflow side of the catalytic filter 100 may include a plurality of first recessed portions 110 and a plurality of first surfaces 120S.

Referring to FIG. 7, the outflow side of the catalytic filter 100 may include a plurality of second recessed portions 120 and a plurality of second surfaces 110S. The plurality of second recessed portions 120 may be outlets from which purified air is discharged. The purified air discharged through the second recessed portions 120 may be air obtained by removing the first compounds from the unpurified air 130 introduced through the first recessed portions 110, or may be air containing harmless gases obtained by breaking down the first compounds.

The plurality of second recessed portions 120 may be regularly and/or periodically arranged along the direction of the X-axis and/or the direction of the Z-axis in FIG. 7. The plurality of second surfaces 110S may be regularly arranged. The plurality of second surfaces 110S may be disposed between the plurality of second recessed portions 120.

The plurality of second surfaces 110S may correspond to the plurality of first recessed portions 110, and the plurality of second recessed portions 120 may correspond to the plurality of first surfaces 120S.

Referring to FIGS. 5 and 7, a second surface 110S may serve as the bottom portion of a first recessed portion 110, and a first surface 120S may correspond to the bottom portion of a second recessed portion 120.

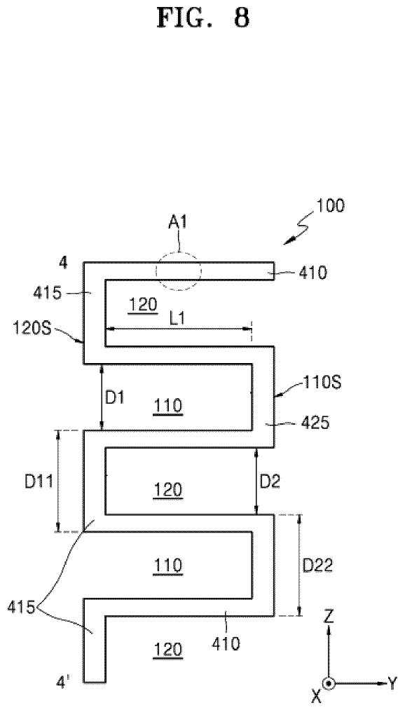

FIG. 8 is a cross-sectional view taken along line 4-4′ in FIG. 6.

The catalytic filter 100 may be a single-body structure, or a single-body frame. The catalytic filter 100 may have a frame that is entirely formed of one material, for example, a ceramic material, a polymer material, a metal material, or the like. The catalytic filter 100 may have, for example, a single-body structure or a monolithic structure, where the entire structure is connected as a single unit. Alternatively, the catalytic filter 100 may be a multilayer structure or a multilayer frame. Although not illustrated in the drawings, the catalytic filter 100 may have, for example, a multilayer structure including a solid substrate and a composite catalyst disposed on the solid substrate. Referring to FIG. 8, the catalytic filter 100 may be a structure having a frame in which a plurality of first recessed portions 110 and second recessed portions 120 are sequentially arranged along the direction of the Z-axis. The catalytic filter 100 may include a plurality of horizontal areas 410 and a plurality of vertical areas 415, 425. The plurality of horizontal areas 410 may be spaced apart from one another along the direction of the Z-axis. The direction of the Z-axis corresponds to a vertical direction. The plurality of horizontal areas 410 may be arranged parallel to one another along the direction of the Y-axis. The plurality of horizontal areas 410 may have the same length or different lengths from each other. The plurality of horizontal areas 410 may be disposed between the plurality of vertical areas 415, 425. The plurality of horizontal areas 410 may be physically connected to one another through the plurality of vertical areas 415, 425. The plurality of vertical areas 415, 425 may be arranged parallel to one another, and spaced apart from one another. The plurality of vertical areas 415, 425 may be spaced apart from one another along the direction of the Z-axis. The direction of the Z-axis corresponds to a vertical direction. The plurality of vertical areas 415, 425 may be arranged parallel to one another along the direction of the Y-axis. The plurality of vertical areas 415, 425 may have the same length or different lengths from each other. The plurality of vertical areas 415, 425 may be disposed between the plurality of horizontal areas 410. The plurality of vertical areas 415, 425 may be physically connected to one another through the plurality of horizontal areas 410. The plurality of vertical areas 415, 425 may include a plurality of first vertical areas 415 and a plurality of second vertical areas 425. The plurality of first vertical areas 415 and the plurality of second vertical areas 425 may be spaced apart from one another along the direction of the Y-axis. The plurality of first vertical areas 415 may be spaced apart from one another along the direction of the Z-axis. The plurality of second vertical areas 425 may be spaced apart from one another along the direction of the Z-axis. The plurality of first vertical areas 415 may be disposed on the inflow side to which the unpurified air 130 is supplied. The plurality of second vertical areas 425 may be disposed on the outflow side from which the purified air 140 is discharged.

The plurality of horizontal areas 410 may correspond to walls of the first recessed portion 110 and second recessed portion 120. The plurality of horizontal areas 410 may be located between the first recessed portion 110 and the second recessed portion 120, thereby serving as boundaries of each of the first and second recessed portions 110, 120.

The walls may correspond to sidewalls of the first recessed portion 110 and the second recessed portion 120. The plurality of horizontal areas 410 may have the same thickness or different thicknesses from each other. The plurality of horizontal areas 410 may have the same thickness as or a different thickness from a thickness of the plurality of vertical areas 415, 425. The horizontal areas 410 that serve as the walls of the first recessed portion 110 may be spaced apart from each other by a first distance D1 along the direction of the Z-axis. The horizontal areas 410 that serve as the walls of the second recessed portion 120 may be spaced apart from each other by a second distance D2 along the direction of the Z-axis. The first distance D1 and the second distance D2 may be the same or different from each other. The opening of the first recessed portion 110 and the opening of the second recessed portion 120 may have the same diameter and/or surface area or have different diameters and/or surface areas from each other. A Y-axis length L1 of each of the plurality of horizontal areas 410 may be the same or different from each other. The depth of a first recessed portion 110 and a second recessed portion 120 may be defined by the Y-axis length L1 of a horizontal area 410. The first recessed portion 110 and the second recessed portion 120 may have the same depth or different depths from each other. The plurality of first vertical areas 415 may form the bottom portions of the second recessed portions 120. The plurality of second vertical areas 425 may form the bottom portions of the first recessed portions 110. The bottom portions of the first recessed portions 110 and the bottom portions of the second recessed portions 120 may have the same air permeability or different air permeability from each other. A diameter D11 of a first vertical area 415 and a diameter D22 of a second vertical area 425 may be the same or different from each other. The first vertical area 415 and the second vertical area 425 may have the same thickness or different thicknesses from each other along the direction of the Y-axis.

The plurality of horizontal areas 410 and the plurality of vertical areas 415, 425 may be formed of the same material and may have a single-body or monolithic structure where the entire structure is connected as a single unit.

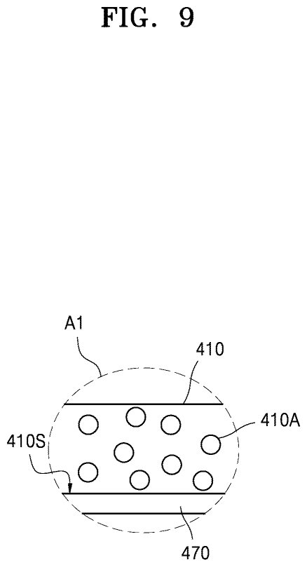

FIG. 9 is an enlarged view of a first area A1 of a horizontal area 410 in FIG. 8.

Referring to FIG. 9, the horizontal area 410 may include pores 410A. The vertical areas 415, 425 may include pores or may not include pores.

The horizontal area 410 and the vertical areas 415, 425 may include pores, and a pore density of the vertical areas 415, 425 may be higher or lower than a pore density of the horizontal area 410.

For example, the first vertical area 415 may include pores, and the second vertical area 425 may not include pores. Alternatively, the first vertical area 415 may not include pores, and the second vertical area 425 may include pores.

The first vertical area 415 and the second vertical area 425 may include pores, and a pore density of the second vertical area 425 may be higher or lower than a pore density of the first vertical area 415.

A catalyst layer 470 including a composite catalyst may be disposed on one surface 410S of the horizontal area 410. The catalyst layer 470 may be disposed, for example, in both the horizontal areas 410 and the vertical areas 415 and 425.

### Method of Preparing the Composite Catalyst for H₂-SCR

A method of preparing a composite catalyst for H₂-SCR, according to an embodiment, is as follows.

In order to prepare a composite catalyst for H₂-SCR, first, a support is provided. Subsequently, the provided support is impregnated with a platinum-containing salt and a platinum group element-containing salt as catalyst particle precursors to obtain a support having supported catalyst particle precursors; the support having the supported catalyst particle precursors is mixed with a reducing agent to obtain a mixture, and then the mixture is optionally dried and heat-treated.

The reducing agent is, for example, hydrazine, sodium borohydride, or a combination thereof. The content of the reducing agent is about 0.1 parts by weight to about 50 parts by weight, about 1 part by weight to about 30 parts by weight, or about 2 parts by weight to about 20 parts by weight, based on 100 parts by weight of the support. When the content of the reducing agent is within the above range, the platinum-containing salt and the platinum group element-containing salt, which are catalyst particle precursors, may be easily reduced into platinum and the platinum group element, respectively.

Any platinum-containing salt may be used as the platinum-containing salt, and examples thereof may include platinum-containing halogen salts, platinum-containing nitrates, platinum-containing carbonates, platinum-containing phosphates, platinum-containing sulfates, or combinations thereof. The platinum group element-containing salt may include halogen salts, nitrates, carbonates, phosphates, sulfates, or combinations thereof, each containing a platinum group element.

The method of impregnating the support with the platinum-containing salt and the platinum group element-containing salt may include, for example, dry impregnation, deposition precipitation, coprecipitation, wet impregnation, sputtering, gas-phase grafting, liquid-phase grafting, or the like.

The optional drying is carried out at about 65° C. to about 85° C. Drying time varies depending on the drying temperature, but the drying is carried out for about 20 hours to about 30 hours or for 24 hours.

The content of the catalyst particles precursor may be about 0.1 parts by weight to about 5 parts by weight, about 0.1 parts by weight to about 3 parts by weight, or about 0.1 parts by weight to about 1 part by weight, based on 100 parts by weight of the support.

When the content of the catalyst particles precursor is within the above range, a composite catalyst having excellent harmful gas removal performance may be prepared.

After drying as described above to obtain a dried product, heat treatment thereof is performed. The heat treatment may be performed at a temperature of about 300° C. to about 900° C., about 400° C. to about 700° C., or about 500° C. to about 600° C. The heat treatment may be performed for about 1 hour to about 24 hours, about 2 hours to about 12 hours, or about 3 hours to about 6 hours, in an oxidizing atmosphere or an inert atmosphere. The inert atmosphere may include, for example, a nitrogen atmosphere, an argon atmosphere, or a combination thereof. The oxidizing atmosphere may include, for example, an oxygen atmosphere, an air atmosphere, etc.

When preparing a composite catalyst, a support in which mesopores are formed may be used as the support. The support may have micropores and mesopores.

A support having mesopores formed therein, for example, aluminosilicate having mesopores formed therein may be prepared by the following method.

The support is a support having mesopores, and the support having mesopores is prepared by processes of: providing a bare support; contacting the bare support with an alkaline solution to prepare an alkali-treated support; performing heat-treatment on the alkali-treated support to prepare a heat-treated porous support; contacting the heat-treated porous support with an ammonium salt-containing solution to prepare an ion exchange-treated support; and optionally drying and then heat-treating the ion exchange-treated support.

Bare support such as aluminosilicate is, for example, zeolite. The type of zeolite used is not limited. Examples of zeolites include, but are not limited to, beta zeolite, ZSM-5, FAU, MFI, BEA, and MOR, and any zeolite used in the relevant technical field may be used.

The alkaline solution may be an aqueous alkaline solution. The concentration of the alkaline solution may be, for example, 0.01 molar (M) or more, about 0.01 M to about 0.5 M, or about 0.05 M to about 0.3 M. The alkaline solution may include, for example, an alkaline compound. The alkaline compound may be, but is not limited to, NaOH, KOH, RbOH, CsOH, or the like, and any alkaline compound used in the relevant technical field may be used. The temperature of the alkaline solution may be, for example, about 20° C. to about 100° C., about 20° C. to about 50° C., or about 20° C. to about 40° C.

In the process of contacting the bare support with an alkaline solution to prepare an alkali-treated support, the time for which the bare support such as aluminosilicate is contacted with the alkaline solution may be, for example, about 1 minute to about 24 hours, about 5 minutes to about 12 hours, about 10 minutes to about 6 hours, about 10 minutes to about 2 hours, or about 10 minutes to about 1 hour. A porous support such as aluminosilicate having an increased pore size may be prepared by contacting the bare support such as aluminosilicate with the alkaline solution.

In the process of preparing an ion exchange-treated support, examples of the ammonium salt may include, but are not limited to, ammonium nitrate, ammonium sulfate, and ammonium chloride, and any ammonium salt used in the relevant technical field may be used. The concentration of the ammonium salt-containing solution may be, for example, about 0.1 M to about 5 M, about 0.1 M to about 3 M, or about 0.5 M to about 2 M. The temperature of the ammonium salt-containing solution may be, for example, about 50° C. to about 100° C., about 70° C. to about 100° C., or about 70° C. to about 90° C. The time for contacting the alkali-treated support such as aluminosilicate with the ammonium salt solution may be, for example, about 30 minutes to about 24 hours, about 30 minutes to about 12 hours, about 30 minutes to about 6 hours, or about 30 minutes to about 2 hours.

In the process of optionally drying and then heat-treating the ion exchange-treated support, the optional drying may be performed at a temperature of about 100° C. to about 120° C. The drying time varies depending on the drying temperature, but, for example, the drying may be carried out for about 10 hours to about 24 hours.

The heat treatment may be performed, for example, at about 65° C. to about 90° C. and for about 0.5 hours to about 1.5 hours. The heat treatment may be performed at about 450° C. to about 650° C. and for about 2 hours to about 10 hours, in an inert gas atmosphere.

According to an embodiment, the support having mesopores are produced by the processes of: introducing a support into a NaOH aqueous solution of about 0.5 to about 1.5 M, stirring the solution at about 65° C. to about 90° C. for about 0.5 to about 1.5 hours to obtain an alkali-treated product, separating the alkali-treated product, washing the separated product with distilled water several times, and drying the washed product to obtain an alkali-treated support; and introducing the alkali-treated support into an ammonium nitrate (NH₄NO₃) aqueous solution of about 0.5 M to about 1.5 M, stirring the solution at about 65° C. to about 90° C. for about 0.5 hours to about 1.5 hours to perform ion exchange, washing the ion-exchanged product, and then drying the washed product at about 100° C. to about 120° C. overnight to obtain a dry product. Then, this dry product may be calcined at about 450° C. to about 600° C., for example, 550° C., for about 2 hours to about 10 hours in an inert atmosphere to obtain a support having mesopores.

Optionally, a substituent group may be introduced, wherein at least one hydrogen in an unsubstituted moiety is replaced with another atom or functional group. Unless otherwise indicated, when a functional group is considered to be “substituted”, it means that the functional group is substituted with at least one substituent group such as a C₁—C₄₀ alkyl group, a C₂-C₄₀ alkenyl group, a C₂-C₄₀ alkynyl group, a C₃-C₄₀ cycloalkyl group, a C₃-C₄₀ cycloalkenyl group, and a C₇-C₄₀ aryl group. When a functional group is described as being “optionally substituted”, this means that the functional group may or may not be substituted with any one of the aforementioned substituent groups.

As used herein, a and b in “Cₐ-C_{b}” represent the number of carbon atoms in a specific functional group. Here, the functional group may include a to b number of carbon atoms. For example, “C₁-C₄ alkyl group” refers to an alkyl group having 1 to 4 carbon atoms, such as CH₃—, CH₃CH₂—, CH₃CH₂CH₂—, (CH₃)₂CH—, CH₃CH₂CH₂CH₂—, CH₃CH₂CH(CH₃)—, and (CH₃)₃C—. A given number or range of carbon atoms of a compound or moiety is exclusive of any substituents, for example a —CH₂CH₂CN moiety is a substituted C₂ alkyl group.

A particular radical may be called a mono-radical or a di-radical depending on the context. For example, when a substituent group needs two binding sites for binding with the rest of the molecule, the substituent may be understood as a di-radical. For example, a substituent group specified as an alkyl group that needs two binding sites may be a di-radical, such as —CH₂—, —CH₂CH₂—, and —CH₂CH(CH₃)CH₂—. The term “alkylene” as used herein clearly indicates that the radical is a di-radical.

The terms “alkyl group” and “alkylene group” as used herein refer to a branched or unbranched aliphatic hydrocarbon group. Examples of the alkyl group include, without being limited to a methyl group, an ethyl group, a propyl group, an isopropyl group, a butyl group, an isobutyl group, a tert-butyl group, a pentyl group, and a hexyl group, each of which may be optionally substituted or unsubstituted. In an embodiment, the alkyl group may have 1 to 6 carbon atoms. For example, the alkyl group having 1 to 6 carbon atoms may be methyl, ethyl, propyl, isopropyl, butyl, iso-butyl, sec-butyl, pentyl, 3-pentyl, hexyl, or the like.

The term “alkenyl group” as used herein refers to a hydrocarbon group having 2 to 40 carbon atoms with at least one carbon-carbon double bond. Examples of the alkenyl group include an ethenyl group, a 1-propenyl group, a 2-propenyl group, a 2-methyl-1-propenyl group, a 1-butenyl group, and a 2-butenyl group. In an embodiment, the alkenyl group may be substituted or unsubstituted. In an embodiment, the alkenyl group may have 2 to 20 carbon atoms.

In this specification, the term “alkynyl group” refers to a C₂-C₄₀ hydrocarbon group including at least one carbon-carbon triple bond. Examples of the alkynyl group may include an ethynyl group, a 1-propynyl group, a 1-butynyl group, and a 2-butynyl group.

In an embodiment, the alkynyl group may be substituted or unsubstituted. In an embodiment, the alkynyl group may have 2 to 20 carbon atoms.

As used herein, the term “cycloalkyl group” refers to a fully saturated carbocyclic ring or ring system. For example, the cycloalkyl group may refer to a cyclopropyl group, cyclobutyl group, cyclopentyl group, or cyclohexyl group.

The term “aromatic” as used herein refers to a ring or ring system with a conjugated n electron system, and may refer to a carbocyclic aromatic group (e.g., a phenyl group) and a heterocyclic aromatic group (e.g., pyridine). In this regard, an aromatic ring system as a whole may include a monocyclic ring or a fused polycyclic ring (i.e., a ring that shares adjacent atom pairs).

The term “aryl group” as used herein refers to an aromatic ring or ring system (i.e., a ring fused from at least two rings that shares two adjacent carbon atoms) having only carbon atoms in its backbone, or a plurality of aromatic rings that are linked by a single bond, —O—, —S—, —C(═O)—, —S(═O)₂—, —Si(Ra)(Rb)— (where Ra and Rb are each independently a C₁-C₁₀ alkyl group), a C₁-C₁₀ alkylene group unsubstituted or substituted with a halogen, or —C(═O)—NH—. The aryl group may be substituted or unsubstituted, and may contain, for example, a phenyl group, a biphenyl group, a naphthyl group, a phenanthrenyl group, a naphthacenyl group, etc.

As used herein, the term “arylene group” refers to an aryl group that requires at least two linking sites. A tetravalent arylene group may be an aryl group that requires four linking sites, and a divalent arylene group may be an aryl group that requires two linking sites. For example, the divalent arylene group may be —C₆H₅—O—C₆H₅— or the like.

As used herein, the term “heteroaryl group” refers to an aromatic ring system with one ring, a plurality of rings that are fused to each other, or an aromatic ring system having a plurality of rings that are linked by a single bond, —O—, —S—, —C(═O)—, —S(═O)₂—, —Si(Ra)(Rb)— (where Ra and Rb are each independently a C₁-C₁₀ alkyl group), a C₁-C₁₀ alkylene group unsubstituted or substituted with a halogen, or —C(═O)—NH—, in which at least one member of the aromatic ring system is a heteroatom, i.e., not carbon. In the fused ring system, at least one heteroatom may be present in only one ring. For example, the heteroatom may be oxygen, sulfur, or nitrogen, but is not limited thereto. Examples of the heteroaryl group include, but are not limited to, a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, and an indolyl group.

As used herein, the term “heteroarylene group” may refer to a heteroaryl group that requires at least two linking sites. A tetravalent heteroarylene group may be a heteroaryl group that requires four linking sites, and a divalent heteroarylene group may be a heteroaryl group that requires two linking sites.

As used herein, the term “aralkyl group” or “arylalkyl group” refers to an aryl group linked to a substituent via an alkylene group, such as a C₇-C₁₄ aralkyl group. Examples of the aralkyl group may include, but are not limited to, a benzyl group, a 2-phenylethyl group, a 3-phenylpropyl group, and a naphthylalkyl group. In an embodiment, the alkylene group may be a lower alkylene group (i.e., a C₁-C₄ alkylene group).

As used herein, the term “cycloalkenyl group” refers to a carbocyclic ring or ring system with at least one double bond without an aromatic ring. For example, the cycloalkenyl group may be a cyclohexenyl group.

As used herein, the terms “heterocyclic group” refers to a non-aromatic ring or ring system including at least one heteroatom in its cyclic backbone.

The term “halogen” as used herein refers to a stable element belonging to Group 17 of the periodic table, for example, fluorine, chlorine, bromine, or iodine. For example, the halogen may be fluorine, chlorine, or a combination thereof.

Hereinafter, one or more embodiments will be described in greater detail with reference to the following examples. However, it will be understood that these examples are provided only to illustrate the present disclosure, and not intended to limit the scope of the one or more embodiments of the present specification.

### EXAMPLES

### Preparation of Mesoporous Support

### Preparation Example 1: MZSM-5

ZSM-5 (Zeolite Socony Mobil-5 manufactured by ACS Material LLC) (SiO₂:Al₂O₃=23:1) was introduced into a 1 M NaOH aqueous solution and stirred at 80° C. for 1 hour to obtain an alkali-treated product. The alkali-treated product was separated, washed with distilled water several times, and dried. Thus, an alkali-treated ZSM-5 was prepared. The content of distilled water is 10 parts by weight per 1 part by weight of the alkali-treated product.

The alkali-treated ZSM-5 was introduced into a 1 M ammonium nitrate (NH₄NO₃) aqueous solution and stirred at 80° C. for 1 hour to perform ion exchange. Then, the resultant product was separated, washed several times, and then dried overnight at a temperature of 110° C. to obtain a dried product. This dried product was calcined at 550° C. for 4 hours in an inert atmosphere to obtain a mesoporous support mZSM-5.

### Preparation Example 2: mZSM-5

A mesoporous support mZSM-5 was obtained in the same manner as in Preparation Example 1, except that ZSM-5 was introduced into a 0.5 M NaOH aqueous solution and stirred at 80° C. for 2 hours to obtain the alkali-treated product.

### Preparation Example 3: mZSM-5

A mesoporous support mZSM-5 was obtained in the same manner as in Preparation Example 1, except that ZSM-5 was introduced into a 0.5 M NaOH aqueous solution and stirred at 80° C. for 1 hour to obtain the alkali-treated product.

### Preparation of Composite Catalyst

### Example 1: Composite Catalyst (Pt:Pd=9:1/HZSM5) (Dry Impregnation)

27 milligrams (mg) of a H₂PtCl₆·6H₂O, 2.5 mg of a Pd(NO₃)₂ and 400 ml of water were added to 1 grams (g) of zeolite HZSM5(CBV2314 manufactured by Zeolyst Inc.)(SiO₂:Al₂O₃ weight ratio=23:1) to obtain a mixture. In Example 1, a precursor was supported on a support by dry impregnation to prepare a composite catalyst. In the dry impregnation, 0.4 g of water was used as a solvent.

The mixing ratio of 27 mg of the H₂PtCl₆·6H₂O and 2.5 mg of the Pd(NO₃)₂ was adjusted so that the weight ratio of platinum and palladium in the finally obtained composite catalyst was 9:1.

Hydrazine as a reducing agent was added to the mixture to perform a reduction reaction, and the reacted mixture was dried at 80° C. for 24 hours to obtain a dried product. Here, the content of hydrazine is 20 parts by weight based on 100 parts by weight of HZSM5.

The obtained dried product was calcined at 500° C. for 4 hours to prepare a composite catalyst in which Pt/Pd particles at a weight ratio of 9:1 are supported. The content of Pt/Pd particles in the composite catalyst is 1.1 parts by weight based on 100 parts by weight of the composite catalyst.

### Example 2: Composite Catalyst (Pt:Pd=8:2(4:1)/HZSM5) (Dry Impregnation)

A composite catalyst in which Pt/Pd particles at a weight ratio of 8:2 are supported was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 8:2.

### Example 3: Composite Catalyst (Pt:Pd=9:3 (3:1)/HZSM5) (Dry Impregnation)

A composite catalyst was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 9:3(3:1).

### Example 4: Composite Catalyst (Pt:Pd=9:1/mZSM-5) (Dry Impregnation)

A composite catalyst was prepared in the same manner as in Example 1, except that mZSM-5 obtained in Preparation Example 1 was used as a support.

### Example 5: Composite Catalyst (Pt:Pd=9:1/HZSM5) (Wet Impregnation)

A composite catalyst was prepared in the same manner as in Example 1, except that wet impregnation was performed instead of dry impregnation according to the following process.

Water was added to 1 g of zeolite HZSM5 (SiO₂/Al₂O₃=23) and dispersed to prepare an aqueous HZSM5 zeolite dispersion. Here, the water content is 1000 parts by weight per 100 parts by weight of zeolite HZSM5.

27 mg of a H₂PtCl₆·6H₂O, 2.5 mg of a Pd(NO₃)₂, and 400 mg of water were added to the aqueous HZSM5 zeolite dispersion to obtain a mixture. The mixture was prepared by wet impregnation. In the wet impregnation, 10 g of water was used as a solvent.

The mixing ratio of the H₂PtCl₆·6H₂O and the Pd(NO₃)₂ was adjusted so that the weight ratio of platinum and palladium in the finally obtained composite catalyst was 9:1.

Hydrazine as a reducing agent, was added to the mixture to perform a reduction reaction, and the reacted mixture was dried at 80° C. for 24 hours to obtain a dried product.

Here, the content of hydrazine is 20 parts by weight based on 100 parts by weight of HZSM5.

The obtained dried product was calcined at 500° C. for 4 hours to prepare a composite catalyst in which Pt/Pd particles at a weight ratio of 9:1 are supported. The content of Pt/Pd particles in the composite catalyst is 1.1 parts by weight based on 100 parts by weight of the composite catalyst.

### Example 6: Composite Catalyst (Pt:Pd=9:1/HZSM5) (Reducing Agent: Sodium Borohydride (NaBH₄), Dry Impregnation)

A composite catalyst was prepared in the same manner as in Example 1, except that sodium borohydride is used instead of hydrazine as a reducing agent and the content of sodium borohydride is 2.5 parts by weight based on 100 parts by weight of the total weight of HZSM5,

### Example 7: Composite Catalyst (Pt:Pd=9:1/HZSM5) (Reducing Agent: Sodium Borohydride (NaBH₄), Wet Impregnation)

A composite catalyst was prepared in the same manner as in Example 5, except that sodium borohydride is used instead of hydrazine as a reducing agent and a cleaning process described below is added.

A reduction reaction was performed by adding sodium borohydride, a reducing agent, to the above mixture, and a washing process was performed using water. Then, the washed result was dried at 80° C. for 24 hours to obtain a dried product.

When sodium borohydride is used as a reducing agent, a cleaning process for removing sodium and boron must be added compared to when hydrazine is used as a reducing agent, thereby lengthening the preparation process.

### Example 8: Content of Pt/Pd Particles: 0.5 wt %

A composite catalyst was prepared in the same manner as in Example 1, except that the content of H₂PtCl₆·6H₂O and Pd(NO₃)₂ was adjusted accordingly when preparing the mixture so that the content of Pt/Pd particles in the composite catalyst was changed from 1.1 parts by weight to 0.5 parts by weight.

### Example 9: Content of Pt/Pd Particles: 5 wt %

A composite catalyst was prepared in the same manner as in Example 1, except that the content of H₂PtCl₆·6H₂O and Pd(NO₃)₂ was adjusted accordingly when preparing the mixture so that the content of Pt/Pd particles in the composite catalyst was changed from 1.1 parts by weight to 5 parts by weight.

### Example 10: Composite Catalyst (Pt:Pd=5:1/HZSM5) (Dry Impregnation)

A composite catalyst in which Pt/Pd particles at a weight ratio of 5:1 are supported was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 5:1.

### Example 11: Composite Catalyst (Pt:Pd=6:1/HZSM5) (Dry Impregnation)

A composite catalyst in which Pt/Pd particles at a weight ratio of 6:1 are supported was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 6:1.

### Example 12: Composite Catalyst (Pt:Pd=7:1/HZSM5) (Dry Impregnation)

A composite catalyst in which Pt/Pd particles at a weight ratio of 7:1 are supported was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 7:1.

### Example 13: Composite Catalyst (Pt:Pd=8:1/HZSM5) (Dry Impregnation)

A composite catalyst supported with Pt/Pd particles at a weight ratio of 8:1 was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 8:1.

### Comparative Example 1: Composite Catalyst (Pt:Pd=10:0, Pt/HZSM5)

A composite catalyst was prepared in the same manner as in Example 1, except that 30 mg of a H₂PtCl₆ solution was used alone instead of the H₂PtCl₆·6H₂O and the Pd(NO₃)₂.

### Comparative Example 2: Composite Catalyst (Pt:Pd=0:10, Pd/HZSM5)

A composite catalyst was prepared in the same manner as in Example 1, except that 25 mg of the Pd(NO₃)₂ solution was used alone instead of the H₂PtCl₆·6H₂O and the Pd(NO₃)₂.

### Comparative Example 3: (Pt:Pd=5:5)

A composite catalyst was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 5:5.

### Comparative Example 4: (Pt:Pd=7:3)

A composite catalyst was prepared in the same manner as in Example 1, except that the mixing ratio of the H₂PtCl₆·6H₂O and the Pd(NO₃)₂ was adjusted so that the weight ratio of platinum and palladium in the finally obtained composite catalyst was 7:3.

### Reference Example 1: Pt/m-ZSM5

A composite catalyst was prepared in the same manner as in Comparative Example 1, except that mZSM-5 obtained according to Preparation Example 1 was used as a support,

### Manufacture of Filters and Air Purifiers

### Manufacture Example 1

The composite catalysts prepared in Example 1 were each positioned on a porous support made of glass fiber, to thereby prepare a filter with a catalyst layer disposed on a porous solid substrate.

A tube having an inlet and an outlet was vertically arranged, and the filter was arranged between the inlet and the outlet, wherein while air is supplied through the inlet and discharged through the outlet, the filter was arranged such that the filter intersects the air stream moving from the inlet toward the outlet within the tube. The filter was installed in the tube such that a composite catalyst was positioned upstream of the air stream relative to the porous support. The tube corresponds to a reaction chamber. The tube and the filter correspond to an air purification device.

### Comparative Manufacture Examples 1 to 4

A filter and an air purification device were manufactured in the same manner as in Manufacture Example 1, except that each of the composite catalysts prepared in Comparative Examples 1 to 4 was used instead of the composite catalyst prepared in Example 1.

### Manufacture Examples 2 to 13

A filter and an air purification device were manufactured in the same manner as in Manufacture Example 1, except that each of the composite catalysts prepared in Examples 2 to 13 was used instead of the composite catalyst prepared in Example 1.

### Reference Manufacture Example 1

A filter and an air purification device were manufactured in the same manner as in Manufacture Example 1, except that the composite catalyst prepared in Reference Example 1 was used instead of the composite catalyst prepared in Example 1.

### Evaluation Example 1: Surface Analysis of Composite Catalyst

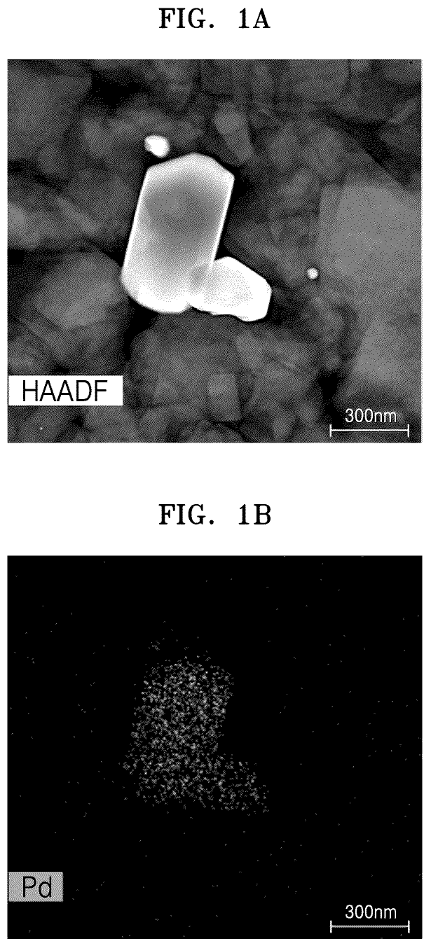

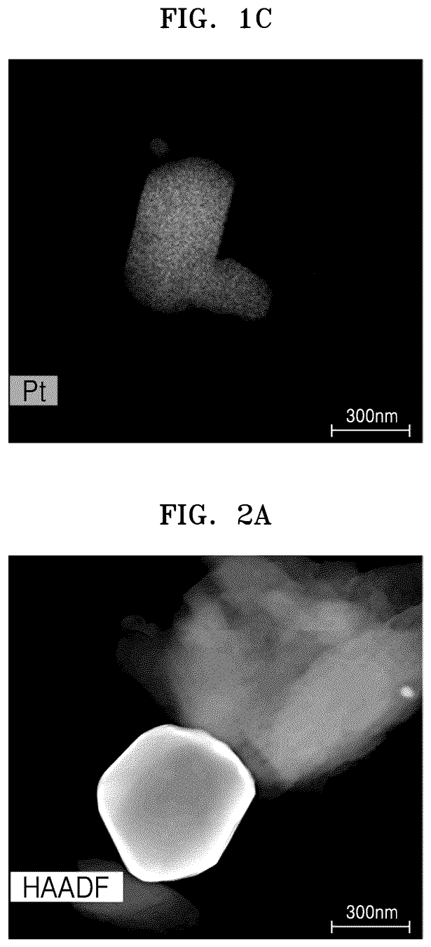

Scanning transmission electron microscopy (STEM)-energy dispersive X-ray (EDX) images of the composite catalysts of Example 1 and Comparative Example 3 were obtained, and the obtained images are shown in FIGS. 1A to 1C and 2A to 2C. FIGS. 1A to 1C are STEM-EDX images of the composite catalyst prepared in Example 1, and FIGS. 2A to 2C are STEM-EDX images of the composite catalyst prepared in Comparative Example 3.

As shown in FIGS. 1A to 1C, the composite catalyst prepared in Example 1 was found to exist in the form of a Pt—Pd alloy by mixing platinum and palladium. The weight ratio of platinum and palladium was confirmed through EDX analysis.

As shown in FIGS. 2A to 2C, the composite catalyst prepared in Comparative Example 3 was found to exist in the form of an alloy in which platinum and palladium are mixed at a weight ratio of 5:5. The weight ratio of platinum and palladium was confirmed through EDX analysis.

### Evaluation Example 2: Brunauer Emmett Teller (BET) Analysis and Barrett-Joyner-Halenda (BJH) Analysis

The specific surface area and total pore volume of each of the supports prepared in Preparation Examples 1 to 3 of the composite catalysts prepared in Example 1 and Comparative Examples 1 and 2 were measured through nitrogen adsorption experiments, and the results thereof are shown in Table 1 below. The mesopore volume and mesopore area of the support were measured through BJH analysis, and the results thereof are shown in Table 1 below.

TABLE 1

| | Class. | | | | |
|---|---|---|---|---|---|
| | | | Preparation | Preparation | Preparation |
| | | | Example 1 | Example 2 | Example 3 |
| | Conditions | ZSM5 | ZSM5 | ZSM5 | ZSM5 |
| Base | NaOH (M) | — | 1 | 0.5 | 0.5 |
| treatment | Time (hr) | — | 1 | 2 | 1 |
| BET | Specific surface area | 356 | 313 | 333 | 294 |
| | a_{s, BET[m}_{²} _{g}_{^{−1}}_{]} | | | | |
| | Total pore | 0.186 | 0.411 | 0.260 | 0.2 |
| | Volume (p/p₀ = 0.990) | | | | |
| | [cm³ g⁻¹] | | | | |
| | Average pore diameter (nm) | 2.092 | 5.259 | 3.121 | 2.722 |
| BJH | Mesopore volume V_{p [cm}_{³} _{g}_{^{−1}}_{]} | 0.0561 | 0.312 | 0.151 | 0.100 |
| | Mesopore area a_{p [m}_{²} _{g}_{^{−1}}_{]} | 21.639 | 77.632 | 67.189 | 46 |

As shown in Table 1, it was found that the largest number of mesopores were formed in the support prepared according to Preparation Example 1. Further, it was found that the support obtained according to Preparation Example 1 includes mesopores having a diameter of 2 to 50 nm and micropores having a diameter of less than 2 nm, and the pore volume of the mesopores is larger than the pore volume of micropores.

### Evaluation Example 3: Evaluation of NO Reduction Performance of Composite Catalyst (I)

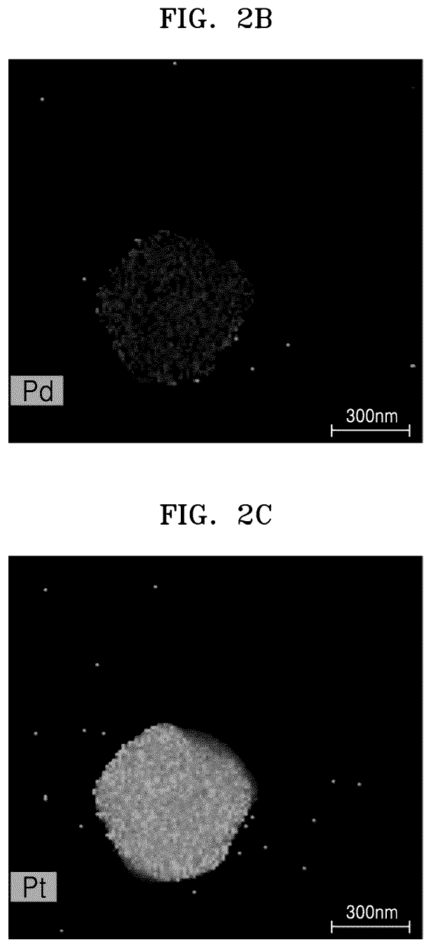

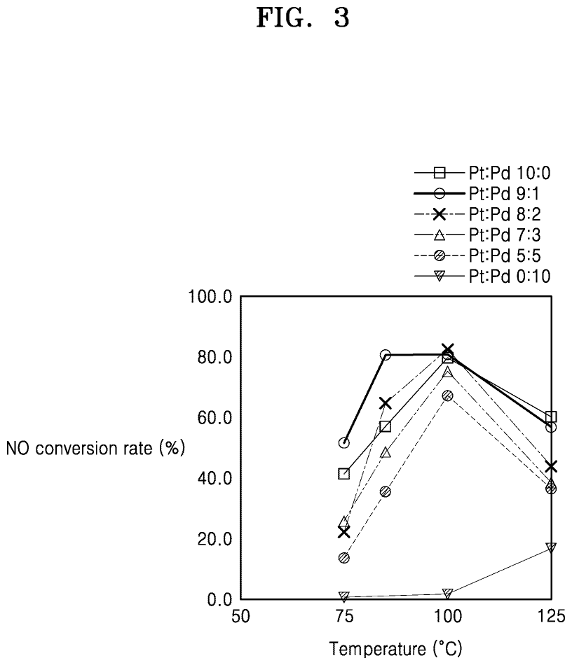

A NOx-containing gas as a first compound was supplied to the inlet of each of the air purification devices of Manufacture Example 1-2 and Comparative Manufacture Example 1-4 manufactured using each of the composite catalysts obtained according to Example 1-2 and Comparative Example 1-4, and was passed through a filter including the catalyst layer and discharged, and then the NO conversion rate and nitrogen selectivity generated by decomposition of NO at the outlet were measured according to temperature. The measurement results of NO conversion and nitrogen selectivity are shown in FIGS. 3 and 4 and Tables 2 and 3. During the measurement, the injection amount of H₂ gas was 4,000 ppm based on the total content of NOx-containing gas (exhaust gas) and hydrogen gas, and the operation temperature was in the range of 75 to 100° C., the oxygen content was 20 vol %, and the nitrogen content was 80 vol %. In NOx-containing gas, the NOx content is 100 ppm.

TABLE 2

| | Class. | | | | | | |
|---|---|---|---|---|---|---|---|
| | NO conversion rate (%) | | | | | | |
| | | | | Comparative | Comparative | Comparative | Comparative |
| Temperature | Example 1 | Example 2 | Example 3 | Example 1 | Example 2 | Example 3 | Example 4 |
| (° C.) | Pt:Pd = 9:1 | Pt:Pd = 8:2 | Pt:Pd = 3:1 | Pt:Pd = 10:0 | Pt:Pd = 0:10 | Pt:Pd = 5:5 | Pt:Pd = 7:3 |
| 75 | 52.1 | 22.7 | 25.8 | 41.8 | 0.8 | 13.8 | 25.8 |
| 85 | 80.8 | 64.9 | 48.5 | 57.7 | — | 35.9 | 48.5 |
| 100 | 81.2 | 82.6 | 75.5 | 80.1 | 2 | 67.1 | 75.5 |

TABLE 3

| | Class. | | | | | | |
|---|---|---|---|---|---|---|---|
| | N2 selectivity (%) | | | | | | |
| | | | | Comparative | Comparative | Comparative | Comparative |
| Temperature | Example 1 | Example 2 | Example 3 | Example 1 | Example 2 | Example 3 | Example 4 |
| (° C.) | Pt:Pd = 9:1 | Pt:Pd = 8:2 | Pt:Pd = 3:1 | Pt:Pd = 10:0 | Pt:Pd = 0:10 | Pt:Pd = 5:5 | Pt:Pd = 7:3 |
| 75 | 51.6 | 34.8 | 41.9 | 44.0 | 0 | 38.4 | 41.9 |
| 85 | 68.9 | 60.3 | 52.6 | 57.0 | 0 | 42.6 | 52.6 |
| 100 | 77.0 | 77.0 | 72.2 | 73.0 | 0 | 62.7 | 72.2 |

As shown in FIG. 3, the air purification device of Manufacture Example 1 using the composite catalyst of Example 1 had an increased conversion rate of 80.8% at 85° C. and an increased conversion rate of 81.2% at 100° C. Further, the air purification device of Manufacture Example 2 using the composite catalyst of Example 2 exhibited an excellent NO conversion rate of more than 40% at 125° C. In this way, the air purification device of Manufacture Examples 1 and 2 using the composite catalysts of Examples 1 and 2 exhibited an improved NO conversion rate at 85° C. to 125° C. as compared with the air purification device of Comparative Manufacture Examples 1 to 4 using the composite catalysts of Comparative Examples 1 to 4 at 85° C. to 125° C. In addition, Comparative Manufacture Example 3 exhibits lower NO conversion rates than Manufacture Examples 1 and 2, at all temperatures of 75, 85, 100, and 125° C., and the air purification device of Comparative Manufacture Example 1 using the composite catalyst of Comparative Example 1 exhibited a lower NO conversion rate at 85° C. than the air purification devices of Manufacture Examples 1 and 2 using the composite catalysts of Examples 1 and 2.

Referring to Tables 2 and 3, when the Pt content in the composite catalyst is lowered and the Pd content is higher, the Pd content, which has a low H₂-SCR efficiency under high O₂ concentration conditions, increases on the surface and thus the efficiency decreases. However, when the Pt content increases and a small amount of Pd is combined with Pt in the form of an alloy, the NOx removal efficiency seems to increase as compared to when Pt is used alone. The test results showed that as compared to when Pt was used alone (Pt:Pd=10:0), the NO conversion rate decreased when Pt and Pd were mixed (7:3, 5:5), but when the ratio of Pt and Pd was 8:2 or more, the NO conversion rate at 100° C. or lower increased rapidly, and thus the highest activity was shown at a low temperature (85° C.).

Meanwhile, the air purification devices of Manufacture Examples 8 to 13 using the composite catalysts of Examples 8 to 13 were evaluated in the same manner as the NOX conversion rate and N₂ selectivity of the air purification device of Manufacture Example 1 using the composite catalyst of Example 1.

As a result of the evaluation, the air purification device of Manufacture Examples 8 to 13 using the composite catalysts of Examples 8 to 13 showed a nitrogen oxide conversion rate and nitrogen selectivity at the same level as the air purification device of Manufacture Example 1 using the composite catalyst of Example 1.

### Evaluation Example 4: Evaluation of NO Reduction Performance of Composite Catalyst (II)

A NOₓ-containing gas as a first compound was supplied to the inlet of each the air purification devices of Manufacture Examples 1 and 4 and Comparative Manufacture Example 1 manufactured using each of the composite catalysts obtained according to Examples 1 and 4 and Comparative Example 1, and was passed through a filter including the catalyst layer and discharged, and then the NO conversion rate generated by decomposition of NO at the outlet was measured according to temperature. Some of the measurement results are shown in Table 4 below. The NOₓ content of the NOₓ-containing gas used for measurement was 100 ppm, the H₂ gas content was 10,000 ppm, the oxygen content was 20 vol %, the nitrogen content was 80 vol %, the relative humidity (25° C.) was 50%, and the space velocity was 240,000 milliliters per gram per hour (ml/g·hr).

TABLE 4

| | Class. | | |
|---|---|---|---|
| | NO conversion rate (%) | | |
| | Manufacture | Manufacture | Comparative |
| | Example 1 | Example 4 | Manufacture Example 1 |
| | (Example 1) | (Example 4) | (Comparative Example 1) |
| Temperature | Pt:Pd 9:1 | Pt:Pd = 9:1 | Pt:Pd 10:0 |
| (° C.) | HZSM5 | m-HZSM5 | HZSM5 |
| 100 | 81.2 | 89.0 | 80.1 |

As shown in Table 4, it can be found that the air purification device of Manufacture Example 4 using the composite catalyst of Example 4 uses a support having mesopores, and has an improved NO conversion rate compared to the air purification device of Manufacture Example 1 using the composite catalyst of Example 1 using a bare support and the air purification device of Comparative Manufacture Example 1 using the composite catalyst of Comparative Example 1. These results came about because the composite catalysts with supports having mesopores facilitate material transfer and thus increase activity.

### Evaluation Example 5: Evaluation of NO Reduction Performance of Composite Catalyst (III)

A NOₓ-containing gas as a first compound was supplied to the inlet of each the air purification devices of Manufacture Examples 1 and 5 to 7 manufactured using each of the composite catalysts obtained according to Examples 1 and 5 to 7, and was passed through a filter including the catalyst layer and discharged, and then the NO conversion rate generated by decomposition of NO at the outlet were measured according to temperature. The NOₓ content of the NOₓ-containing gas used for measurement was 100 ppm, the H₂ gas content was 40,000 ppm, the oxygen content was 20 vol %, the nitrogen content was 80 vol %, the relative humidity was 50%, the temperature was 25° C., and the space velocity was 240,000 ml/g·hr.

As a result of the evaluation, it was found that the composite catalysts of Examples 1 and 5 to 7 were prepared using hydrazine and sodium borohydride as reducing agents, and had excellent NO conversion rates and N₂ selectivities.

In addition, it was found that the composite catalysts of Examples 1 and 6 prepared by dry impregnation had improved NO conversion and N₂ selectivity compared to the composite catalysts of Examples 5 and 7 prepared by wet impregnation.

### Evaluation Example 6: Inductively Coupled Plasma Spectrometry (ICP) Analysis

ICP analysis was performed on the composite catalysts prepared according to Example 1 and Comparative Examples 1 to 4, and the analysis results thereof are shown in Table 5 below.

TABLE 5

| | | | Total content | |
|---|---|---|---|---|
| Class. | Pt content | Pd content | of Pt + Pd | Weight ratio |
| (Pt:Pd ratio) | (wt %) | (wt %) | (wt %) | of Pt:Pd |
| Example 1 (9:1) | 1.01 | 0.1 | 1.11 | 9.1:0.9 |
| Comparative | 1.1 | — | 1.1 | 10:0 |
| Example 1 (10:0) | | | | |
| Comparative | — | 1.08 | 1.08 | 0:10 |
| Example 2 (0:10) | | | | |
| Comparative | 0.59 | 0.48 | 1.07 | 5.5:4.5 |
| Example 3 (5:5) | | | | |
| Comparative | 0.81 | 0.3 | 1.11 | 7.3:2.7 |
| Example 4 (7:3) | | | | |

As shown in Table 5, it was found that the composite catalysts of Example 1 and Comparative Examples 1 to 4 had a constant total metal content of 1.1 wt %, and, as a result of ICP analysis, the mixing ratio of platinum and palladium used as starting materials in the preparation of the composite catalysts of Example 1 and Comparative Examples 1 to 4 was maintained without significant difference.

According to an aspect, the composite catalyst for H₂-SCR has higher activity at lower reaction temperature than a catalyst containing only platinum, and can provide improved ability to remove harmful gases such as nitrogen oxides.

Heretofore, an embodiment has been described in greater detail with reference to the accompanied drawings; however, the present inventive concept is not limited to these examples. While one or more embodiments have been described with reference to the figures, it will be understood by those of ordinary skill in the art that various changes in form and details may be made therein without departing from the spirit and scope of the disclosure as defined by the following claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite catalyst for hydrogen-selective catalytic reduction, wherein the composite catalyst is configured to remove a first compound from an unpurified air stream containing the first compound, the composite catalyst comprising:
a support; and
catalyst particles supported on the support,
wherein the catalyst particles comprise a metal, a metal oxide, or a combination thereof,
the metal comprises platinum and a platinum group element different from platinum, and
a content of the platinum is 3 parts by weight or more per 1 part by weight of the platinum group element.

2. The composite catalyst of claim 1, wherein the platinum group element is palladium, ruthenium, rhodium, osmium, iridium, or a combination thereof.

3. The composite catalyst of claim 1, wherein a mixing weight ratio of the platinum and the platinum group element is about 3:1 to about 1,000:1.

4. The composite catalyst of claim 1, wherein a content of the catalyst particles is about 0.1 weight percent to about 5 weight percent, based on a total weight of the composite catalyst.

5. The composite catalyst of claim 1, wherein the metal oxide is PtOₓ wherein 0<x≤2, PdO_{y} wherein 0<x≤1, RuOₓ wherein 0<x≤2, OsOₓ wherein 0<x≤2, IrOₓ wherein 0<x≤2, RuₐOₓ wherein 0<a≤2, 0<x≤3, or a combination thereof.

6. The composite catalyst of claim 1, wherein the support is SiO₂, Al₂O₃, zeolite, TiO₂, or a combination thereof.

7. The composite catalyst of claim 1, wherein the composite catalyst comprises platinum and palladium.

8. The composite catalyst of claim 7, wherein the composite catalyst further comprises an oxide of platinum and an oxide of palladium.

9. The composite catalyst of claim 1, wherein the composite catalyst is represented by Formula 1:
PtₓPd_{y} Formula 1
wherein, in Formula 1, 0.8≤x≤0.99, and 0.01≤y≤0.2.

10. The composite catalyst of claim 1, wherein
the support further comprises mesopores, and
the mesopores have an average size of about 2 nanometers to about 50 nanometers.

11. The composite catalyst of claim 10, wherein
the support is aluminosilicate,
a ratio of silicon to aluminum in the aluminosilicate is 50 or less, and
a volume of the mesopores in the support is about 20% to about 80%.

12. The composite catalyst of claim 1, wherein the composite catalyst is capable of use under conditions of an O₂ content of about 5 volume percent to about 20 volume percent and a temperature of about 70° C. to 125° C.

13. The composite catalyst of claim 1, wherein the composite catalyst has an NO conversion rate of 40% or more and a N₂ selectivity of more than 60% under conditions of an O₂ content of about 5 volume percent to about 20 volume percent and a temperature of about 70° C. to about 125° C.

14. The composite catalyst of claim 1, wherein the first compound comprises a volatile organic compound,
wherein the volatile organic compound comprises a polar compound, a nonpolar compound, or a combination thereof, wherein the nonpolar compound comprises an aliphatic hydrocarbon, an aromatic hydrocarbon, or a combination thereof,
the polar compound comprises ammonia, urea, an amine compound, an aldehyde compound, a ketone compound, an alcohol compound, a sulfur compound, a thiol compound, a halogenated hydrocarbon, a nitrogen oxide, ozone, or a combination thereof,
the aliphatic hydrocarbon comprises methane, ethane, propane, butane, pentane, hexane, or a combination thereof,
the aromatic hydrocarbon comprises benzene, toluene, xylene, or a combination thereof,
the amine compound comprises methylamine, dimethylamine, trimethylamine, ethylamine, aniline, or a combination thereof,
the aldehyde compound comprises formaldehyde, acetaldehyde, propionaldehyde, butyraldehyde, or a combination thereof,
the ketone compound comprises dimethyl ketone, methyl ethyl ketone, diethyl ketone, methyl propyl ketone, dipropyl ketone, or a combination thereof,
the alcohol compound comprises methanol, ethanol, propanol, isopropanol, butanol, pentanol, hexanol, heptanol, or a combination thereof,
the sulfur compound comprises hydrogen sulfide, sulfur dioxide, elemental sulfur, sulfur oxide, or a combination thereof, and
the thiol compound comprises methanethiol, ethanethiol, 1-propanethiol, 2-propanethiol, butanethiol, tert-butyl mercaptan, thiophenol, or a combination thereof.

15. A method of preparing a composite catalyst for hydrogen-selective catalytic reduction, the method comprising:
providing a support;
supporting a platinum-containing salt and a platinum group element-containing salt that does not include platinum as catalyst particle precursors on the support to obtain a support on which the catalyst particle precursors are supported; and
mixing the support on which the catalyst particle precursors are supported with a reducing agent to obtain a mixture on the support;
optionally, drying the mixture on the support; and
heat-treating the dried mixture on the support to prepare the composite catalyst of claim 1.

16. The method of claim 15, wherein the heat treating is performed at about 300° C. to about 900° C. in an inert gas atmosphere.

17. The method of claim 15, wherein the support is a support having mesopores, and wherein the support having mesopores is prepared by processes of:
providing a bare support;
contacting the bare support with an alkaline solution to prepare an alkali-treated support;
heat treating the alkali-treated support to prepare a heat-treated porous support;
contacting the heat-treated porous support with an ammonium salt-containing solution to prepare an ion exchange-treated support; and
optionally drying the ion exchange-treated support; and
heat-treating the optionally dried ion exchange-treated support.

18. An air purification device comprising:
a housing; and
the composite catalyst of claim 1,
wherein the composite catalyst is located within the housing.

19. The air purification device of claim 18, wherein
the air purification device has an operation temperature of about 70° C. to about 125° C.,
an oxygen content of about 5 volume percent to about 20 volume percent, and
a nitrogen content of about 80 volume percent to about 95 volume percent.

20. The air purification device of claim 18, wherein in the air purification device, an amount of hydrogen gas injected is about 100 parts per million to about 40,000 parts per million, based on a total weight of exhaust gas and hydrogen gas.
